(19) United States
(12) Patent Application Publication
(10) Pub. No.: US 2005/0052731 A1
(43) Pub. Date: Mar. 10, 2005

(54) Optical amplifier control in wdm communications systems

(76) Inventors: Benjamin John Corr, Worcestershire (GB); Steven Ian Pegg, Northants (GB); Robert Richard Packham, Coventry (GB)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 10/491,256

(22) PCT Filed: Sep. 11, 2002
(86) PCT No.: PCT/GB02/04135

(30) Foreign Application Priority Data
Oct. 9, 2001 (GB) 0124258.5

(51) Int. Cl. H01S 3/00

(52) U.S. Cl. 359/341.41

(57) ABSTRACT

A system for controlling gain of an optical amplifier that is disposed in a WDM optical communication network for amplifying an input WDM signal to produce a corresponding amplified output WDM signal is operative for measuring average optical powers of the input WDM signal over first and second wavebands, each covering a wavelength range that includes at least one wavelength channel of the WDM network and is operative for measuring the average optical powers of the amplified output WDM signal over the first and second wavebands. The system further determines gain values over the first and second wavebands from the average input and output powers and adjusts a variable of the optical amplifier to ensure that the difference between the gain values is maintained to within a predetermined value thereby ensuring a substantially flat gain slope profile.

This invention relates to a system and method for controlling optical amplifiers in WDM communications systems. More especially the invention concerns controlling the gain of the optical amplifier to maintain a flat gain profile over the WDM wavelength spectrum.

Erbium doped fibre amplifiers (EDFAs) are widely used in wavelength division multiplexing (WDM) systems. The amplifiers should ideally have a flat gain profile across the spectral band in which the amplifier is operating. Typically values of ±0.5 dB are acceptable in optical telecommunication networks.

The gain profile of an EDFA changes as operating conditions change. For example, a change in input power to the EDFA, or a change of temperature of the EDFA, will cause the gain to “slope”. By “slope” it is meant that the gain at one end of the operating wavelength spectrum is larger than at the other end.

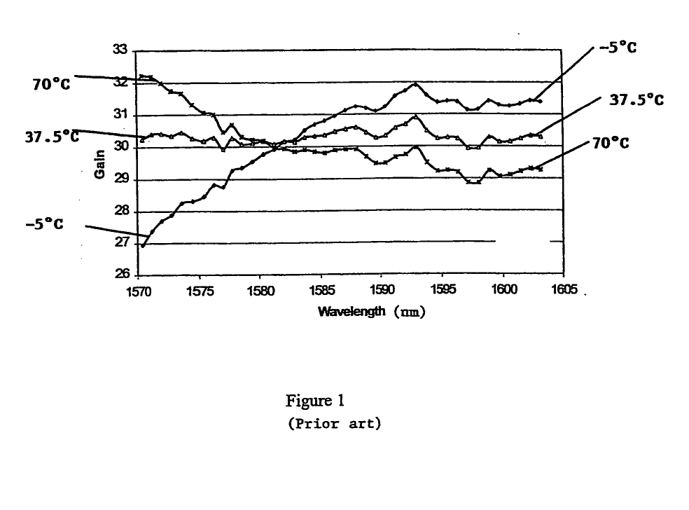

Referring to FIG. 1, the variation in spectral gain of a typical L-band (long wavelength operation band ˜-1570-1605 nm) EDFA with temperature is shown. As the temperature increases, the gain in the fibre changes from having higher gain at the red (longer wavelength) end of the operating spectrum, to having higher gain at the blue (shorter wavelength) end of the operating spectrum. The amplifier is designed so at a nominal temperature (37.5° C. in the example illustrated) the gain is substantially flat over the operating spectrum (1570 nm to 1603 nm).

The rate at which the gradient of the gain slope changes with respect to temperature change is dependent on the amount of erbium (Er) doping in the amplifier. Higher levels of Er doping increase the gain slope change for a given change in temperature. Under normal operating conditions this can be approximated by ΔG/G=kΔT, where ΔG is the peak gain variation, G is the mean amplifier gain, ΔT is the change in temperature and k is an amplifier dependent constant.

It is known that an EDFA operating in the L-band (1570 nm to 1605 nm) has a lower operational inversion population (that is the ratio of excited state Er³⁺ ions to ground state Er³⁺ ions) than a C-band EDFA amplifier operating between 1532 nm to 1561 nm. As a result, L-band amplifiers require a greater number of Er³⁺ ions than C-band amplifiers to achieve the same gain. It follows that L-band erbium doped amplifiers will exhibit a greater variation of gain with respect to temperature than a C-band erbium doped amplifier with equivalent gain.

At present, compensation for this change in gain is controlled by changing a loss in a system. In one known example, the loss is controlled by a variable optical attenuator (VOA) placed between the gain stages in a multi-stage EDFA. By reducing the signal input power into a gain stage, fewer photons are able to deplete the Er³⁺ ions in the excited state, thus more excited ions remain in the excited state. The relatively higher number of Er³⁺ ions in the excited state increases the gain at shorter operational wavelengths, and so the gain slope of the latter stage is tilted towards the blue (shorter wavelength) end of the operational spectrum. Conversely, increasing the input power by reducing the mid-stage loss tilts the gain slope to the red (Conger wavelength) end of the operating spectrum.

Such an amplifier system must be pre-calibrated for automatic control of the VOA. The pre-calibration requires the amplifier to be characterised over a temperature range before the amplifier is put into service. Typically, the amplifier includes a temperature monitor and an attenuation value for the VOA is selected on the basis of the measured temperature.

Furthermore, the pump power into the final amplification stage is changed to compensate for output power variations. The output power from the amplifier is measured by splitting-off a small amount of the output signal using an optical tap and measuring this split-off signal using a photo-diode. The pump power is controlled in a feedback loop with this measured output.

The amplifier maintains a substantially flat gain profile and constant output power across the operating spectrum using the two processes described above.

In present amplifier systems characterisation of the VOA settings must be performed fully for each amplifier design. A graph of the attenuation required against temperature is approximately linear and depends on a number of variables. These variables include the amount of erbium doping and the characteristics of individual amplifiers associated with component losses and build variations, for example fibre splicing losses. The slope is assumed to be constant for all amplifiers built of a given type. Limited measurements of individual amplifiers are necessary to determine a build variation offset.

There are disadvantages with this control system. Firstly, the characterisation of the amplifier is lengthy and is even more time consuming as the number of amplifier derivatives in a system increases. The time taken to characterise such a system is excessive and burdensome.

Furthermore, the amplifier is controlled according to its initial characterisation. The control system does not have the ability to predict the behaviour of an amplifier over its lifetime. Effects, such as ageing of the doped fibre or components, wavelength shift of the pump laser, or the need to run the amplifier at temperatures/input powers outside the calibrated range, may result in a degradation of an amplifier system performance. There is little experience of how ageing affects the characteristics of EDFAs, or their components.

It is also known to use heaters to maintain constant fibre temperatures, thus negating the need to compensate for temperature variation. However, signal input power variations may still be required for controlling such systems. Also, the heaters require an electrical power supply and a thermostatic control system to operate the heater element in the amplifier box, adding expense and mechanical complexity to the design.

The present invention alms to ameliorate the problems associated with the prior art. In its broadest form, the invention controls the amplifier characteristics from empirical information taken during amplifier operation.

More specifically, there is provided a system for controlling gain of an optical amplifier, the optical amplifier being disposed in a WDM optical communication network for amplifying an input WDM signal to produce a corresponding amplified output WDM signal, the system being characterised by: means for measuring average optical powers of the input WDM signal over first and second wavebands, said first and second wavebands each covering a wavelength range that includes at least one wavelength channel of the WDM network; means for measuring average optical powers of the amplified output WDM signal over the first and second wavebands; means for determining gain values over the first and second wavebands from the average input and output powers; and means for adjusting a variable of the optical amplifier such that the difference between the gain values is maintained to within a predetermined value.

The present invention has the advantages that the network is protected from unforeseen changes in amplifier behaviour. By using empirical information the system can adapt as changes occur or as changes are made to the network.

Preferably the means for measuring average optical powers of the input WDM signal over the first and second wavebands comprises: a first sampler for sampling a first amount of the input signal; a splitter for splitting the sampled WDM signal into the two wavebands; and a detector for measuring the power of the sampled signal over the first and second wavebands.

Similarly the means for measuring average optical powers of the amplified output WDM signal over the first and second wavebands advantageously comprises: a second sampler for sampling a second amount of the output signal; a splitter for splitting the sampled WDM signal into the two wavebands; and a detector for measuring the power of the sampled signal at the first and second wavebands.

Advantageously the first and second sampler comprise an optical tap, such as an optical fibre splice.

In a preferred implementation the amplifier includes a variable optical attenuator for variably attenuating the input WDM signal and wherein the variable for controlling the difference between gain values is the attenuation of the attenuator.

Alternatively, or in addition, the amplifier can include temperature controlling means for controlling the temperature of the optical amplifier and wherein the variable for controlling the difference between gain values is the temperature of the amplifier.

Advantageously the optical amplifier comprises at least one EDFA gain stage.

Preferably each waveband has a wavelength range which includes a plurality of wavelength channels of the WDM network. Such an arrangement ensures the presence of radiation power within each band thereby enabling the average power over each waveband at the input and output to be determined.

In a particularly preferred arrangement the first and second wavebands are located on either side of a central operating wavelength channel. To ensure there is a maximum number of channels present in each waveband, each waveband advantageously has a wavelength range including a respective half of the WDM wavelength channels.

According to a second aspect of the invention there is provided a wavelength division multiplexing optical communication network incorporating the system described above.

There is further provided a method for controlling gain of an optical amplifier in a WDM optical communication network, the amplifier being for amplifying an input WDM signal to produce a corresponding amplified WDM signal, the method comprising: measuring average optical powers of the input WDM signal over first and second wavebands, said first and second wavebands each covering a wavelength range that includes at least one wavelength channel of the WDM network; measuring average optical powers of the amplified output WDM signal over the first and second wavebands; determining gain values over the first and second wavebands from the average input and output powers; and adjusting a variable of the optical amplifier such that the difference between the gain values is maintained to within a pre-determined value.

Advantageously the method further comprises sampling a first amount of the input WDM signal; splitting the WDM signal into a plurality wavebands; and measuring the average power of the sampled signal over the first and second wavebands.

Preferably the method further comprises sampling a second amount of the amplified WDM signal; splitting the WDM signal into a plurality wavebands; and measuring the average power of the sampled signal over the first and second wavebands.

Preferably each of the first and second wavebands are disposed either side of a central operating wavelength channel and advantageously has a wavelength range which includes a plurality of wavelength channels.

An embodiment of the present invention is now described, by way of example only, with reference to the accompanying figures, in which;

FIG. 1 is a graph of gain versus wavelength for an EDFA at different temperatures and discussed above;

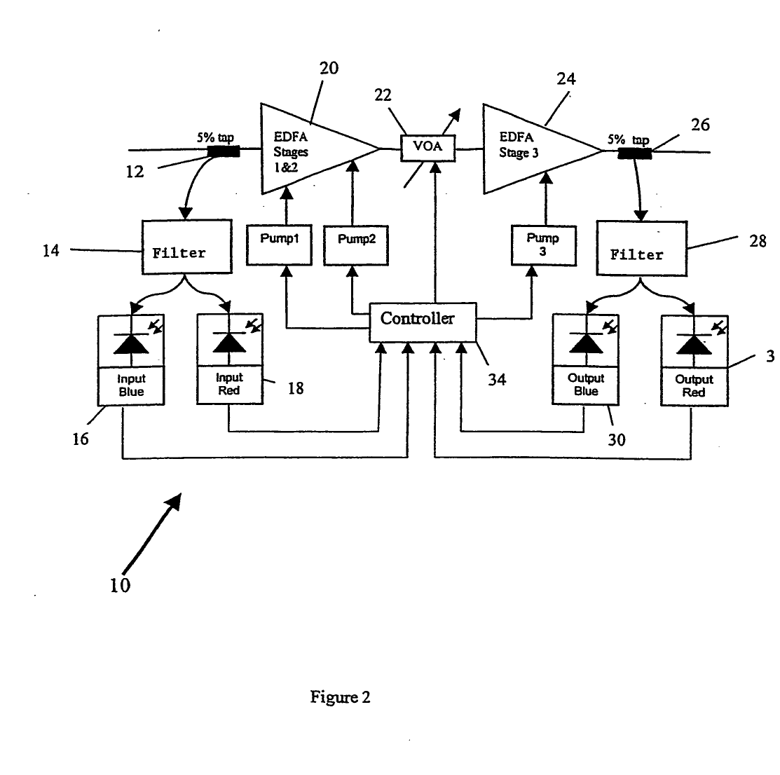

FIG. 2 is a schematic representation of a system embodying the present invention for controlling an optical amplifier;

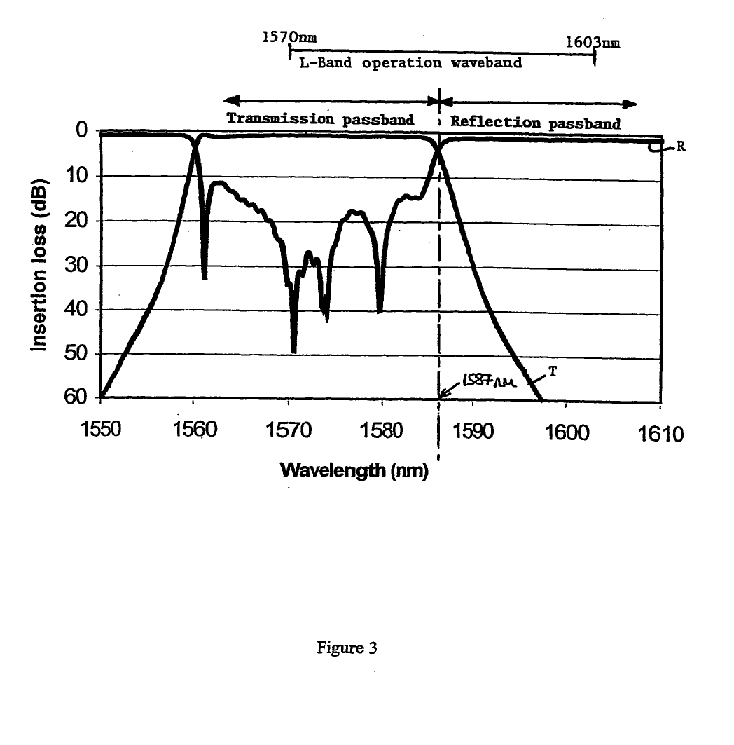

FIG. 3 is a graph showing the transmission and reflection characteristics with wavelength of a filter arrangement used in an embodiment of the present invention;

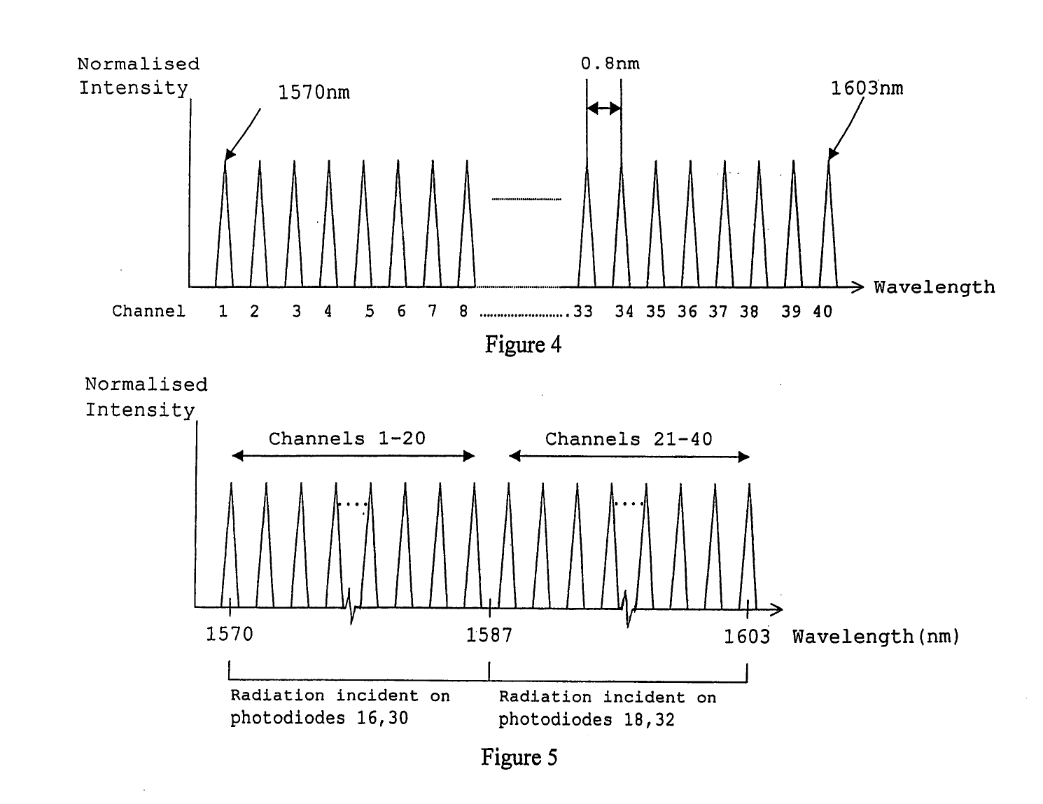

FIG. 4 is a graph representing a number of the forty optical channels transmitted in a preferred embodiment; and

FIG. 5 is a graphical representation of the optical channels incident on the photodiodes in the preferred embodiment.

Referring to FIG. 2, an EDFA amplifier system 10 embodying the present invention is shown comprising three gain stages 20, 24. The amplifier system is intended for use in a forty channel dense WDM communication system operating within L-band (1570 nm-1603 nm) with a 100 GHz (0.8 nm) spacing of optical wavelength channels. An optical tap 12 samples an input WDM optical signal as the signal enters the amplifier system. The input sample is split into two wavebands, by a filter, or splitter 14.

The filter 14 is designed to reflect and transmit radiation incident on it to respective outputs. The reflected and transmitted radiation correspond to the two wavebands. The spectral characteristic (insertion loss versus wavelength) of the filter is shown in FIG. 3 for both transmission (T) and reflection (R). The input signal is split into a first lower waveband 1570-1587 nm and a second upper waveband 1587-1603 nm disposed either side of a central operational wavelength (approximately the centre wavelength for L-band operation, 1587 nm).

It will be noted from FIG. 3 that the transmission and reflection passbands of the filter actually correspond approximately to 1560-1587 nm and 1587-1610 nm respectively. Although these passbands will allow radiation to pass which is outside L-band operation (1570 nm-1603 nm), no significant radiation outside the L-band is present on the system described. The choice of this wavelength split is arbitrary. However, sufficient signal power in each waveband is required to monitor the amplifier gain. That is, a signal on at least one channel in each waveband is required to monitor the amplifier gain at all times. Respective photodiodes 16, 18 measures a signal strength (power) of each waveband.

Referring to FIG. 4 and FIG. 5, a representation of the forty optical channels of the WDM signal with respect to wavelength is shown. The channels numbered 1 to 20 are in the lower waveband of 1570 nm to 1586 nm, and the channels numbered 21 to 40 are in the upper waveband 1587 nm to 1603 nm. Referring to FIG. 3 discussed above, the transmission characteristics of the filter 14 show it has relatively low loss for a first waveband from 1560 nm to 1587 nm and relatively high loss for a second waveband 1587 nm to 1610 nm. Conversely, the reflection characteristics of the filter show it has relatively high loss in the first waveband and relatively low loss in the second waveband. Thus, the filter 14 splits the forty channels into two twenty channel wavebands, each waveband being either side of a central wavelength, as shown in FIG. 5. Essentially, in this embodiment, the filter behaves as a band-pass filter having high transmission characteristics in one waveband and high reflection characteristics in another adjacent waveband. Such filters can utilise multiple dielectric layers to achieve the required reflective and transmission characteristics.

The remaining majority of the input WDM signal propagates through the first two gain stages 20, to a variable optical attenuator 22 (VOA) and through the third gain stage 24 to the amplifier output. At the output, another sample of the signal is taken by a second optical tap 26. This output sample is split into the same two wavebands as for the input signal by a filter 28 (that is wavelength bands corresponding to wavelength channels 1 to 20, 1570-1587 mn, and channels 21 to 40, 1587-1603 nm). The average signal strength (power) of the two wavebands is measured using a further pair of photodiodes 30, 32.

The photodiodes 16 and 30 measure the input and output signal power values respectively over the first waveband with shorter wavelengths (blue), and the photodiodes 18, 32 measure the input and output signal power values respectively over the second waveband with longer wavelengths (red) than the central wavelength.

The input and output power values for each waveband are assimilated by a control unit 34. The control unit 34 determines the necessary changes of attenuation of the VOA 22 that may be needed for ideal operation of the amplifier system 10. A simple indication of the average gain of the amplifier system can be determined from the following relationships:
ΔGain=G_{red}−Gain_{blue}
where
Gain_{red}=Output_{red}−Input_{red}
and
Gain_{blue}=Output_{blue}−Input_{blue}

Input_{blue} and Input_{red} (as measured by the photodiodes 16 and 18 respectively) are the measured powers in dBm of each of the red and blue wavebands at the input to the amplifier system. Likewise, Output_{blue} and Output_{red} (as measured by the photodiodes 30 and 32 respectively) are the measured powers in dBm of each of these red and blue wavebands at the output of the amplifier system. Gain_{red} and Gain_{blue} are the average gains of each waveband over the amplifier system.

Ideally, for the amplifier to have a flat gain/wavelength response, or spectral profile, ΔGain=0. When ΔGain>0 a gain slope favouring longer (red) wavelength channels is present. Conversely, when ΔGain<0 a gain slope favouring shorter (blue) wavelength channels is present.

Thus, the magnitude and sign of ΔGain can be used by the controller 34 to control the attenuation of the VOA 22, and hence the amplification gain response of the third gain stage 24. This in turn controls the amplifier system output. By changing the attenuation, the gain spectrum can be flattened to achieve ΔGain≅0. If ΔGain>0, the attenuation is increased, and if Gain<0 the attenuation is decreased.

Variations caused by system components mean that ideal operation is not necessarily achieved when ΔGain=0; it is likely to be offset by a small amount. In one system implementation, an optimum value of ΔGain=0.3 dB has been measured.

It will be appreciated that in the amplifier system of the present invention the sampled input and output signals are used in a feedback loop with the controller and VOA to control the amplifier system characteristics. If the characteristics of the various gain stages, or amplifier components, change then the feedback loop makes changes to VOA attenuation level so that the amplifier continues to perform to an optimum. In this way, any long term degradation, or short term variation of the amplifier components, that could have otherwise lead to degradation of the amplifier's performance, can be compensated for. This results in an increased operational lifetime, or increase period between service.

In other embodiments it is envisaged to improve the accuracy of the monitoring process by splitting the sampled signals into more than two wavebands.

Optical taps and VOAs are well known and typically have a flat spectral response.

Splitting or dividing the signal into the wavelength sub-bands can be achieved using known methods such as diffraction gratings or interference filters. Furthermore, photodiodes with integral filters can be used.

The VOA 22 is shown in FIG. 2 placed between the second and third gain stage. Its position is not limited and it can be placed before any of the gain stages. However the position described in the preferred embodiment is considered to give optimal signal to noise ratio performance of the output signal.

Furthermore, it is not essential that the optical taps 12, 26 are placed at the input and output. For example, the taps can be positioned between amplification stages, but at least one amplifier must remain between the taps. The power sampled by each tap is arbitrary. FIG. 2 shows taps 12, 26 that samples 5% of the signal power. Other taps that sample more or less power would work equally well. Consideration of the amount of power sampled is needed so that not too much power is removed from the signal yet sufficient is sampled to allow accurate measurement by the photodiodes. Furthermore, the output tap 26 does not need to sample the same percentage amount as the input tap 12. In this instance, a correction factor is required in the controller so that the gain values are correctly calculated.

If fibre temperature control systems are available for use, the feedback system could be used to control fibre temperature, rather than, or as well as, the attenuation of the VOA. Also, control of the amplifier pumps (denoted Pump 1 to Pump 3 in FIG. 2) could be used to maintain output power levels.

The embodiment described has three gain stages in one amplifier system. Of course, a number of gain stages can be used with any combination of sampling points and feedback loops.

1-14. (Canceled)

15. A system for controlling gain of an optical amplifier disposed in a wavelength division multiplexing (WDM) optical communication network, the optical amplifier being operative for amplifying an input WDM signal to produce a corresponding amplified output WDM signal, the system comprising:
a) means for measuring average optical powers of the input WDM signal over first and second wavebands, the first and second wavebands each covering a wavelength range that includes at least one wavelength channel of the WDM network;
b) means for measuring average optical powers of the amplified output WDM signal over the first and second wavebands;
c) means for determining gain values over the first and second wavebands from the average input and output optical powers; and
d) means for adjusting a variable of the optical amplifier such that a difference between the gain values is maintained to within a predetermined value.

16. The system according to claim 15, in which the means for measuring average optical powers of the input WDM signal over the first and second wavebands comprises: a first sampler for sampling a first amount of the input WDM signal to obtain a sampled input WDM signal; a splitter for splitting the sampled input WDM signal into the two wavebands; and a detector for measuring the optical power of the sampled input WDM signal over the first and second wavebands.

17. The system according to claim 16, in which the means for measuring average optical powers of the amplified output WDM signal over the first and second wavebands comprises: a second sampler for sampling a second amount of the output WDM signal to obtain a sampled output WDM signal; a splitter for splitting the sampled output WDM signal into the two wavebands; and a detector for measuring the optical power of the sampled output WDM signal at the first and second wavebands.

18. The system according to claim 15, in which the optical amplifier includes a variable optical attenuator for variably attenuating the input WDM signal, and wherein the variable for controlling the difference between the gain values is an attenuation of the attenuator.

19. The system according to claim 15, in which the optical amplifier includes temperature controlling means for controlling a temperature of the optical amplifier, and wherein the variable for controlling the difference between the gain values is a temperature of the optical amplifier.

20. The system according to claim 15, in which the optical amplifier comprises at least one erbium doped fiber amplifier gain stage.

21. The system according to claim 15, in which each waveband has a wavelength range which includes a plurality of wavelength channels of the WDM network.

22. The system according to claim 21, in which the first and second wavebands are located on either side of a central operating wavelength channel.

23. A wavelength division multiplexing (WDM) optical communication network incorporating a system for controlling gain of an optical amplifier disposed in the network, the optical amplifier being operative for amplifying an input WDM signal to produce a corresponding amplified output WDM signal, the system comprising:
a) means for measuring average optical powers of the input WDM signal over first and second wavebands, the first and second wavebands each covering a wavelength range that includes at least one wavelength channel of the WDM network;
b) means for measuring average optical powers of the amplified output WDM signal over the first and second wavebands;
c) means for determining gain values over the first and second wavebands from the average input and output optical powers; and
d) means for adjusting a variable of the optical amplifier such that a difference between the gain values is maintained to within a predetermined value.

24. A method of controlling gain of an optical amplifier in a wavelength division multiplexing (WDM) optical communication network, the optical amplifier being operative for amplifying an input WDM signal to produce a corresponding amplified output WDM signal, the method comprising the steps of:
a) measuring average optical powers of the input WDM signal over first and second wavebands, the first and second wavebands each covering a wavelength range that includes at least one wavelength channel of the WDM network;
b) measuring average optical powers of the amplified output WDM signal over the first and second wavebands;
c) determining gain values over the first and second wavebands from the average input and output powers; and
d) adjusting a variable of the optical amplifier such that a difference between the gain values is maintained to within a predetermined value.

25. The method according to claim 24, and comprising the steps of: sampling a first amount of the input WDM signal to obtain a sampled input WDM signal; splitting the sampled input WDM signal into a plurality of wavebands; and measuring the average optical power of the sampled input WDM signal over the first and second wavebands.

26. The method according to claim 25, and comprising the steps of: sampling a second amount of the amplified output WDM signal to obtain a sampled output WDM signal; splitting the sampled output WDM signal into a plurality of wavebands; and measuring the average optical power of the sampled output WDM signal over the first and second wavebands.

27. The method according to claim 24, wherein each of the first and second wavebands is disposed on either side of a central operating wavelength channel.

28. The method according to claim 24, wherein each waveband has a wavelength range which includes a plurality of wavelength channels.
